(19) United States
(12) Patent Application Publication
(10) Pub. No.: US 2014/0278841 A1
(43) Pub. Date: Sep. 18, 2014

(54) REMOTE SENSING OF VEHICLE OCCUPANCY

(71) Applicant: Ron Natinsky, Dallas, TX (US)

(72) Inventor: Ron Natinsky, Dallas, TX (US)

(21) Appl. No.: 14/209,670

(22) Filed: Mar. 13, 2014

Related U.S. Application Data
(60) Provisional application No. 61/794,377, filed on Mar. 15, 2013.

(51) Int. Cl. G07B 15/06

(52) U.S. Cl. CPC G07B 15/06; G06Q 2240/00
USPC 705/13

(57) ABSTRACT

A system for managing a toll-based roadway includes one or more receiving units positioned above or proximate the roadway and a sensing unit positioned within a vehicle traveling on the roadway. The sensing unit is configured to sense occupancy data based on the number of passengers within the vehicle. The occupancy data is communicated to the one or more receiving units.

### CROSS-REFERENCE TO RELATED APPLICATIONS

This application claims the benefit of and priority to U.S. Provisional Patent Application Ser. No. 61/794,377 filed on Mar. 15, 2013, entitled REMOTE SENSING OF VEHICLE OCCUPANCY, which is hereby incorporated by reference.

### BACKGROUND

1. Field

The disclosure generally relates to technologies for determining occupancy of a vehicle for compliance with traffic regulations such as high occupancy vehicle (HOV) lanes, managed lanes, and occupancy-based toll roads.

2. Description of Related Art

Many urban jurisdictions have built or implemented a variety of methods to reduce vehicle traffic, congestion, and to encourage higher occupancy of vehicles, such as installation and control of high occupancy vehicle (HOV) lanes, toll roads, and car pool tax credits.

While cameras recently have been implemented to assess tolls to vehicles on toll roads by automatically recognizing a license plate in a photograph of a vehicle as it passes a toll station, enforcement of occupancy requirements of some lanes has remained primarily a manual process performed by state and local law enforcement agencies. Unlike vehicle-identification systems that track owner information based on a vehicle's license plate, camera-based systems are not able to easily determine the number of passengers in a vehicle due to multiple factors including the inability to view some areas within the vehicle.

### SUMMARY

The problems presented by existing systems and methods for managing toll-based roadways are solved by the systems and methods of the illustrative embodiments described herein. In one embodiment, one or more sensors are interfaced to a controller which in turn interfaces to a transponder in order to provide occupancy status of a vehicle. The one or more sensors determine the occupancy status of one or more of the seats in the vehicle, and report this to the controller. The controller determines an overall occupancy for the vehicle, and provides this information to the transponder. The transponder then communicates this information to a traffic monitoring or toll collection infrastructure, such as to a toll tag reading tower using Radio Frequency Identification (RFID) wireless communication. The collected information may then be used to reduce or eliminate manual occupancy verification by police, and to enable incentive-based toll policy.

In another embodiment, a system for managing a toll-based roadway includes one or more receiving units positioned above or proximate the roadway and a sensing unit positioned within a vehicle traveling on the roadway. The sensing unit is configured to sense occupancy data based on the number of passengers within the vehicle. The occupancy data is communicated to the one or more receiving units.

In yet another embodiment, a method for managing a toll-based roadway, the method comprising determining the number of passengers within a vehicle traveling on the roadway, said step of determining being performed from within the vehicle. The method further includes communicating data related to said number of passengers to a database. A toll is charged based on the number of passengers within the vehicle.

In still another embodiment, a method for managing a toll-based roadway includes determining the number of passengers within a vehicle traveling on the roadway, said step of determining being performed from within the vehicle. The method further includes communicating data related to said number of passengers to a database. A determination is made as to whether a toll is due based on the number of passengers within the vehicle.

Other objects, features, and advantages of the invention will become apparent with reference to the drawings, detailed description, and claims that follow.

### BRIEF DESCRIPTION OF THE DRAWINGS

FIG. 1 illustrates a vehicle equipped with at least one sensor unit, a control unit and a transponder unit, which communicates to a toll tower or a toll accounting system according to one illustrative embodiment; and

FIG. 2 illustrates a generalized computing platform suitable for implementing at least the control unit portion of an illustrative embodiment.

### DETAILED DESCRIPTION OF ILLUSTRATIVE EMBODIMENTS

In the following detailed description of the illustrative embodiments, reference is made to the accompanying drawings that form a part hereof. These embodiments are described in sufficient detail to enable those skilled in the art to practice what is disclosed, and it is understood that other embodiments may be utilized and that logical structural, mechanical, electrical, and chemical changes may be made without departing from the spirit or scope of the disclosure. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

Determining vehicle occupancy for toll-based roadways and managed lanes is useful in setting occupancy-based tolls in order to control motorway congestion and more efficiently use the motorways. When a toll authority is enabled to accurately determine the occupancy status of each vehicle, toll incentives may be offered to vehicle operators who transport larger numbers of occupants in their vehicles, while penalties may be accurately assessed to those who utilize infrastructure such as HOV lanes without meeting the occupancy requirements.

The embodiments described herein include devices or systems that can be installed within an automobile or other vehicle to determine the number of vehicle occupants within a specified transmission range, and to communicate occupancy status to a toll-collection infrastructure. At least one embodiment employs the radio-frequency identification (RFID) infrastructure commonly used in automated toll collection today, but other embodiments may use other forms of wireless communication such as, but not limited to, Bluetooth, Wi-Fi, infrared, or other communication protocols.

A variety of “presence detection” methods may be used alone or in concert to determine occupancy inside the vehicle, including passive infrared motion sensor(s), ultrasonic motion sensor(s), thermopile sensor(s), infrared-sensitive digital camera(s), visible-light or other passive or active sensor(s) to measure body motion and/or body temperature at a distance. Further, human body or facial characteristics may also be used for this determination.

Referring now to FIG. 1, embodiments of this invention may use one or more sensors (102, 102′) to determine if a person is occupying one of several positions in a vehicle (101), e.g. front passenger seat, rear driver side, rear middle or rear passenger side seat. For cost purposes, it is not necessary to implement an occupancy detector for the driver, as it can be reasonably presumed that each moving vehicle which is travelling on a roadway is at least occupied by a driver.

In at least one embodiment, a sensor sensing unit (102, 102′) having one or more of the presence detection technologies may be positioned within the vehicle (101) such that the sensor unit has an unobstructed view of the one or more passenger seats. One or more of the presence detection methods may be used to determine if a person is occupying the one or more passenger seats. This sensor data is communicated to a control unit (110) containing electronic circuits or a processor employing software to determine the presence of a live human, distinguishing it from an object or an animal. The processor may also determine, if passengers are present, the total number of passengers within the vehicle.

This control unit (110) may then communicate the occupancy information to a transponder unit (103) that communicates (104) the information to a receiving unit (105) deployed at sites along the roadway using a wireless communications technology such as RFID. The receiving unit (105) may include a tower, an antenna, a receiver, and other devices associated with toll-based infrastructure. The receiving unit (105) may be positioned above the roadway or otherwise proximate the roadway to receive data from the transponder unit (103). The embodiments described herein may be able to make use of existing RFID technology and systems already deployed for toll collection and other purposes by using the same RFID frequencies, modulation methods and data protocols.

Additional sensor units (102′) may be aimed at or placed near the rear seat to make the same determination for that location. If precise seat occupancy is needed, then it may be necessary to deploy or aim a sensor towards that location. Otherwise, the sensor field of view could encompass a wider area of the rear seat and provide an indication of occupancy, but maybe not an exact count.

The transponder unit, control unit and one or more sensors described above may be packaged together or separately. If packaged separately, then either wired or wireless communication methods are used to transfer information between the sensors, control unit and transponder unit.

It is desired that installation and operation be simple and reliable, therefore at least one embodiment includes the sensor units, control unit and transponder unit packaged together and operating on battery power or solar power. The combination of sensor units, control unit and transponder unit may be positioned on the front dashboard or windshield of the vehicle, or anywhere else within the vehicle, such that the transponder unit has an RF path outside the vehicle and the sensor unit(s) has a view towards the passenger and rear seats.

Suitable Computing Platform.

The preceding paragraphs have set forth example logical processes according to the illustrative embodiments invention that may be coupled with processing hardware to embody other system and processes according to an illustrative embodiment of the invention. Similarly, the previously described processes and systems may be coupled with tangible, computer readable memory devices to embody computer program products according to illustrative embodiments of the invention.

Regarding computers for executing the logical processes set forth herein, a variety of computers or computing devices may be suitable and may include memory, processing, and communications capabilities. In such embodiments, an illustrative embodiment may include the combination of the programmable computing platform and the programs together. In other embodiments, some or all of the logical processes may be committed to dedicated or specialized electronic circuitry, such as Application Specific Integrated Circuits or programmable logic devices.

Embodiments of the invention may be realized for many different processors used in many different computing platforms. FIG. 2 illustrates a generalized computing platform (500), such as common and well-known computing platforms such as “Personal Computers”, and portable devices such as personal digital assistants and smart phones, running an operating system (502) such as Microsoft™ Windows™, Google Android™, Microsoft Windows Mobile™, UNIX, LINUX, Apple iPhone iOS™, or others, may be employed to execute one or more application programs to accomplish the computerized methods described herein. Other suitable computing platforms include embedded processing and control modules, such as those based on the well-known Microchip Technology™ PIC microcontroller provided with suitable software or firmware functions, or even certain mobile computers such as smart phones.

Many of these computing platforms and operating systems are well known and openly described in any number of textbooks, websites, and public “open” specifications and recommendations. Diagrams and further details of these computing systems in general (without the customized logical processes of the embodiments described herein) are readily available to those ordinarily skilled in the art.

Many such computing platforms allow for the addition of or installation of application programs (501) which provide specific logical functionality and which allow the computing platform to be specialized in certain manners to perform certain jobs, thus rendering the computing platform into a specialized machine. In some “closed” architectures, this functionality is provided by the manufacturer and may not be modifiable by the end-user.

The “hardware” portion of a computing platform typically includes one or more processors (504) that may be accompanied by specialized co-processors or accelerators, such as graphics accelerators, and by suitable computer readable memory devices (RAM, ROM, disk drives, removable memory cards, etc.). Depending on the computing platform, one or more network interfaces (505) may be provided, as well as specialty interfaces for specific applications. If the computing platform is intended to interact with human users, it may be provided with one or more user interface devices (507), such as display(s), keyboards, pointing devices, speakers, etc. And, each computing platform requires one or more power supplies, which may include a battery, AC mains, solar power, or other power sources.

The terminology used herein is for the purpose of describing particular embodiments only and is not intended to be limiting of the invention. As used herein, the singular forms “a”, “an” and “the” are intended to include the plural forms as well, unless the context clearly indicates otherwise, It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

It should also be recognized by those skilled in the art that certain embodiments utilizing a microprocessor executing a logical process may also be realized through customized electronic circuitry performing the same logical process(es). Several non-limiting examples of systems and methods for managing a toll-based roadway are provided below.

### EXAMPLE 1

A system for managing a toll-based roadway, the system comprising:
one or more receiving units positioned above or proximate the roadway; and
a sensing unit positioned within a vehicle traveling on the roadway, the sensing unit configured to sense occupancy data based on the number of passengers within the vehicle;
wherein the occupancy data is communicated to the one or more receiving units.

### EXAMPLE 2

The system of example 1, wherein the sensing unit includes one or more infrared sensors for detecting heat or motion within the vehicle.

### EXAMPLE 3

A method for managing a toll-based roadway, the method comprising:
determining the number of passengers within a vehicle traveling on the roadway, said step of determining being performed from within the vehicle;
communicating data related to said number of passengers to a database; and
charging a toll based on the number of passengers within the vehicle.

### EXAMPLE 4

The method of example 3, wherein said step of communicating further comprises:
wirelessly transmitting to a receiving unit positioned above or proximate the roadway.

### EXAMPLE 5

The method of example 3, wherein said step of communicating further comprises:
wirelessly transmitting using a cellular telephone network.

### EXAMPLE 6

The method of any of examples 3-5, wherein said step of determining further comprises:
detecting movement within the vehicle.

### EXAMPLE 7

The method of any of examples 3-5, wherein said step of determining further comprises:
detecting heat within the vehicle.

### EXAMPLE 8

The method of any of examples 3-7, wherein said step of charging further comprises:
charging a higher toll to vehicles having few numbers of passengers.

### EXAMPLE 9

A method for managing a toll-based roadway, the method comprising:
determining the number of passengers within a vehicle traveling on the roadway, said step of determining being performed from within the vehicle;
communicating data related to said number of passengers to a database; and
determining whether a toll is due based on the number of passengers within the vehicle.

### EXAMPLE 10

The method of example 9, wherein said step of communicating further comprises:
wirelessly transmitting to a receiving unit positioned above or proximate the roadway.

### EXAMPLE 11

The method of example 9, wherein said step of communicating further comprises:
wirelessly transmitting using a cellular telephone network.

### EXAMPLE 12

The method any of examples 9-11, wherein said step of determining the number of passengers further comprises:
detecting movement within the vehicle.

### EXAMPLE 13

The method any of examples 9-11, wherein said step of determining the number of passengers further comprises:
detecting heat within the vehicle.

It should be apparent from the foregoing that an invention having significant advantages has been provided. While the invention is shown in only a few of its forms, it is not limited to only these embodiments but is susceptible to various changes and modifications without departing from the spirit thereof.

What is claimed is:

1. A system for managing a toll-based roadway, the system comprising:
one or more receiving units positioned above or proximate the roadway; and
a sensing unit positioned within a vehicle traveling on the roadway, the sensing unit configured to sense occupancy data based on the number of passengers within the vehicle;
wherein the occupancy data is communicated to the one or more receiving units.

2. The system of claim 1, wherein the sensing unit includes one or more infrared sensors for detecting heat or motion within the vehicle.

3. A method for managing a toll-based roadway, the method comprising:
determining the number of passengers within a vehicle traveling on the roadway, said step of determining being performed from within the vehicle;
communicating data related to said number of passengers to a database; and
charging a toll based on the number of passengers within the vehicle.

4. The method of claim 3, wherein said step of communicating further comprises:
wirelessly transmitting to a receiving unit positioned above or proximate the roadway.

5. The method of claim 3, wherein said step of communicating further comprises:
wirelessly transmitting using a cellular telephone network.

6. The method of claim 3, wherein said step of determining further comprises:
detecting movement within the vehicle.

7. The method of claim 3, wherein said step of determining further comprises:
detecting heat within the vehicle.

8. The method of claim 3, wherein said step of charging further comprises:
charging a higher toll to vehicles having few numbers of passengers.

9. A method for managing a toll-based roadway, the method comprising:
determining the number of passengers within a vehicle traveling on the roadway, said step of determining being performed from within the vehicle;
communicating data related to said number of passengers to a database; and
determining whether a toll is due based on the number of passengers within the vehicle.

10. The method of claim 9, wherein said step of communicating further comprises:
wirelessly transmitting to a receiving unit positioned above or proximate the roadway.

11. The method of claim 9, wherein said step of communicating further comprises:
wirelessly transmitting using a cellular telephone network.

12. The method of claim 9, wherein said step of determining the number of passengers further comprises:
detecting movement within the vehicle.

13. The method of claim 9, wherein said step of determining the number of passengers further comprises:
detecting heat within the vehicle.
